(19) United States
(12) Patent Application Publication
(10) Pub. No.: US 2013/0267263 A1
(43) Pub. Date: Oct. 10, 2013

(54) Method of Handling Message Transmission and Related Communication Device

(71) Applicant: HTC CORPORATION, Taoyuan County (TW)

(72) Inventor: Fan-Min Tseng, Taoyuan County (TW)

(73) Assignee: HTC Corporation, Taoyuan County (TW)

(21) Appl. No.: 13/859,696

(22) Filed: Apr. 9, 2013

Related U.S. Application Data
(60) Provisional application No. 61/621,581, filed on Apr. 9, 2012.

(51) Int. Cl. H04W 4/14

(52) U.S. Cl. CPC H04W 4/14
USPC 455/466

(57) ABSTRACT

A method of handling a message service for an Internet Protocol-Short-Message-Gateway (IP-SM-GW) of a wireless communication system comprises requesting routing information of a terminating device in the wireless communication system from a home subscriber server (HSS)/home location register (HLR) of the wireless communication system for a message, wherein the terminating device is attached to a mobility management entity (MME) of the wireless communication system and is registered with short message service (SMS) in MME; and transmitting the short message to the MME via an interface according to the routing information.

### CROSS REFERENCE TO RELATED APPLICATIONS

This application claims the benefit of U.S. Provisional Application No. 61/621,581, filed on Apr. 9, 2012 and entitled “Method of sending IM to MME in SMS user from IM/CPM capable UE”, the contents of which are incorporated herein in their entirety.

### BACKGROUND OF THE INVENTION

1. Field of the Invention

The present invention relates to a method used in a wireless communication system and related communication device, and more particularly, to a method of handling a message transmission and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

“SMS (Short Message Service) in MME (Mobility Management Entity)” is an architecture option primarily intended for networks that do not deploy GERAN or UTRAN. SMS in MME delivers SMS services over EPS NAS signaling for UE's requiring SMS services but not any other CS services. SMS in MME architecture option enables support of SMS in the EPS without requiring deployment of 3GPP Mobile Switching Center (MSC). The MME indicates the “SMS in MME” is required when the MME is registered with a home subscriber server (HSS) if a terminating UE indicates SMS only and/or the MME does not support the reference point SGs. However, a UE which is registered with an MME supporting and performing the “SMS in MME” feature may not be reachable when the UE is not registered in an IP multimedia subsystem (IMS) domain or when the UE has registered in the IMS domain but fails to receive messages from an Internet Protocol-Short-Message-Gateway (IP-SM-GW) due to network error, for example. In addition, the UE which is registered with the MME supporting and performing the “SMS in MME” feature may not successfully receive SMS due to short of memory capacity in the UE. In this situation, an instant message (IM) capable UE or a converged IP messaging (CPM) capable UE may transmit a message (e.g., an instant message, a chat session invitation or a chat session teardown request) to the UE which may not be reachable via an Internet Protocol-Short-Message-Gateway (IP-SM-GW) and the IP-SM-GW cannot forward the message directly to the UE, since the IP-SM-GW is unable to communicate with the MME. Thus, the UE cannot receive the message. It is an issue to be solved how to transmit the message to a UE which is registered with an MME supporting and performing the “SMS in MME” feature but is not registered in IMS domain or is in short of memory capacity.

On the other hand, a short message service centre (SMS-SC) may transmit a short message to a UE in the IMS domain via the IP-SM-GW. In certain situations, the IP-SM-GW may fail to forward the short message in form of a session initiation protocol (SIP) message to the UE because the UE is not reachable in the IMS domain or the UE is in short of memory capacity. Then the IP-SM-GW may try to forward the message directly via the MME to the UE instead, the IP-SM-GW fails again since the IP-SM-GW is unable to communicate with the MME. Thus, transmitting the message directly via the MME to the UE is an important topic to be discussed.

### SUMMARY OF THE INVENTION

The present invention therefore provides a method and related communication device for handling message transmission to solve the abovementioned problem.

A method of handling a message service for an Internet Protocol-Short-Message-Gateway (IP-SM-GW) of a wireless communication system is disclosed. The method comprises requesting routing information of a terminating device in the wireless communication system from a home subscriber server (HSS)/home location register (HLR) of the wireless communication system for a message, wherein the terminating device is attached to a mobility management entity (MME) of the wireless communication system and the MME supports and performs SMS in MME; and transmitting the short message to the MME via an interface according to the routing information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example the present invention.

FIG. 2 is a schematic diagram of a communication device according to an example to the present invention.

FIG. 3 is a flowchart of a process according to an example of the present invention.

### DETAILED DESCRIPTION

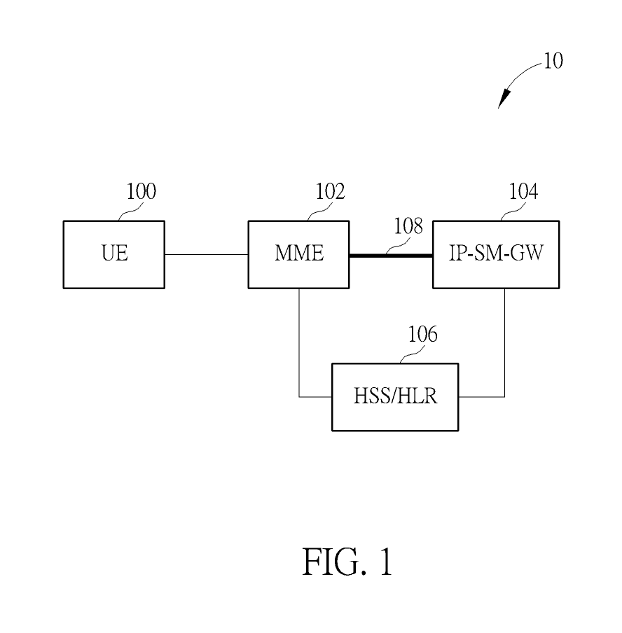

Please refer to FIG. 1, which is a schematic diagram of a wireless communication system 10 according to an example of the present invention. The wireless communication system 10 can be an LTE-A system, briefly composed of a user equipment (UE) 100, an Evolved Universal Terrestrial Radio Access Network (E-UTRAN, not shown), a mobility management entity (MME) 102, an Internet Protocol-Short-Message-Gateway (IP-SM-GW) 104, a home subscriber server (HSS)/home location register (HLR) 106, an interface 108, an SMS-SC (Short Message Service-Service Center, not shown),and an IMS Core (not shown). In detail, the UE 100 can be a mobile phone, a laptop, a tablet computer, an electronic book or a portable computer system. The MME 102 can be seen as a main control node of the core network of the wireless communication system 10, for handing (e.g., processing, transmitting, transforming) a message or a signaling to/from the UE 100 via the E-UTRAN, and the MME 102 is enabled to use the “SMS in MME” feature.

The IP-SM-GW 104 can provide protocol interworking for delivery of a short message between an IP-based UE and the SMS-SC. A short message is forward by the IP-SM-GW 104 from an IP-based UE (as an originating UE) to the SMS-SC via the IMS core, for delivery to an SMS-based UE (as a terminating UE); or, a short message is received from the SMS-SC of an SMS-based UE (as an originating UE) and is routed by the IP-SM-GW 104, for delivery to an IP-based UE (as a terminating UE) via IMS core. In addition, the interface 108 is established between the MME 102 and IP-SM-GW 104 for the “SMS in MME” feature. In “SMS in MME” feature, the HSS/HLR 106 can register the MME 102 as an MSC for MT SMS, when the MME 102 requests a registration for SMS Request. The HSS/HLR 106 allows an operator to configure a subscription, which is limited to only PS domain service and to SMS service via the CS domain and the PS domain.

In FIG. 1, the UE 100, the MME 102, the IP-SM-GW 104 and the HSS/HLR 106 are utilized for illustrating the simplified architecture of the wireless communication system 10. Practically, the UE 100 can communicate with the MME 102 via the E-UTRAN (not shown), which comprises transmission points (TPs) such as a plurality of evolved NBs (eNBs) and/or relays in a long term evolution (LTE) system or a LTE-Advanced (LTE-A) system. In another example, the UE 100 can communicate with the MME 102 via other access technologies, such wireless local area network (WLAN) comprising access points (APs), Worldwide Interoperability for Microwave Access (WiMAX) comprising base stations (BSs), or a universal terrestrial radio access network (UTRAN) comprising a plurality of NodeBs (NBs) in the LTE system, and is not limited herein.

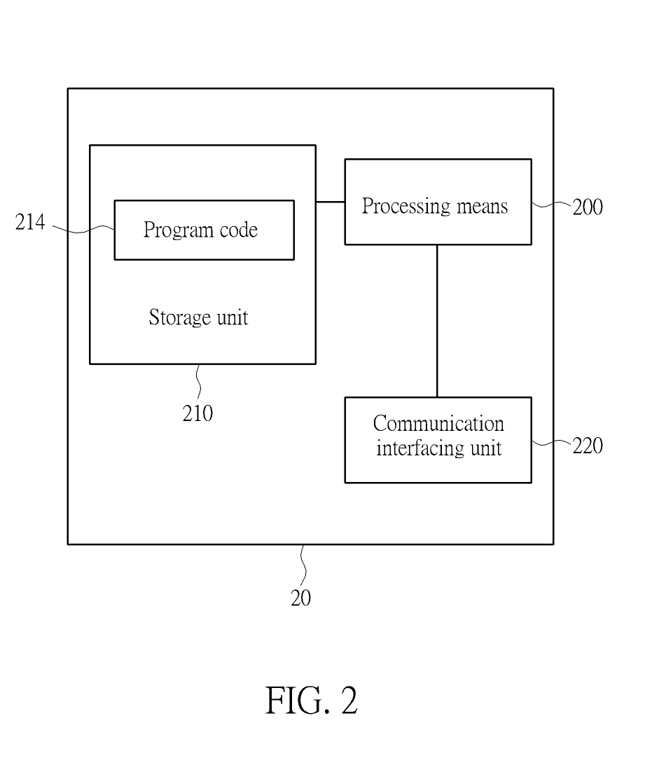

Please refer to FIG. 2, which is a schematic diagram of a communication device 20 according to an example of the present invention. The communication device 20 can be the IP-SM-GW 104 shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or packets) according to processing results of the processing means 200.

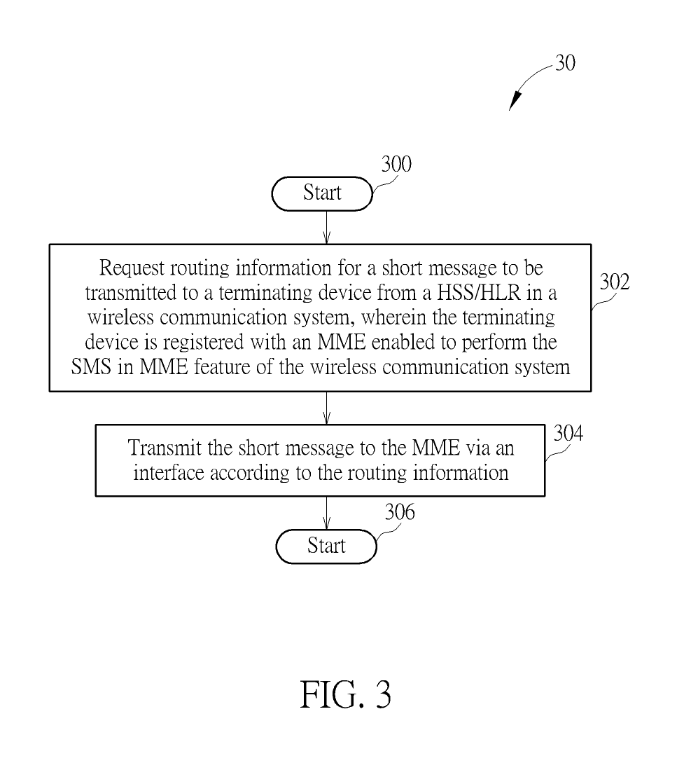

Please refer to FIG. 3, which is a flowchart of a process 30 according to an example of the present invention. The process 30 can be utilized in the IP-SM-GW 104 shown in FIG. 1, for handling a message service. The process 30 may be compiled into the program code 214 and includes the following steps:

Step 300: Start.

Step 302: Request routing information for a short message to be transmitted to a terminating device from a HSS/HLR in a wireless communication system, wherein the terminating device is registered with an MME enabled to perform the SMS in MME feature of the wireless communication system.

Step 304: Transmit the short message to the MME via an interface according to the routing information.

Step 306: End.

Please note that, the terminating device in the process 30 is registered with the MME 102, which is enabled to use the “SMS in MME” feature. In one example, an originating device can be an IM/CPM capable UE and the IM/CPM capable UE may transmit a message, which can be an instant message, a chat session invitation, or a chat session teardown request, to the IP-SM-GW 104 via the IMS core (not shown in FIG. 1). In another example, the originating device can be an SMS-SC. The IP-SM-GW 104 may perform service-level interworking by converting the received message into the short message, and deliver the short message to terminating UE via a legacy network. According to the process 30, the IP-SM-GW 104 first requests routing information for the short message to be transmitted to the terminating UE 100 from the HSS/HLR 106. Then, the IP-SM-GW 104 may transmit the short message to the MME 102 via the interface 108 (e.g., a reference point, a protocol) according to the routing information. The MME 102 can then forward the short message to the UE 100. Note that the interface 108 can be a newly defined interface, established between the IP-SM-GW 104 and the MME 102 such that the IP-SM-GW 104 is able to communicate with the MME 102.

In the prior art, the short message may not be delivered to a terminating UE registered with the MME supporting and performing the “SMS in MME” feature, if the terminating UE is not reachable in the IMS domain or is in short of memory capacity. As a result, the terminating UE may not receive short messages converted from the message from the originating IM/CPM UE. In comparison, according to the process 30, even though the terminating UE 100 is not reachable in the IMS domain or is in short of memory capacity, the IP-SM-GW 104 can still transmit the short message to the MME 102 via the interface 108 according to the routing information.

Please note that, realization of the process 30 is not limited. For example, the routing information may include an address of the MME 102, such that the IP-SM-GW 104 can transmit the short message to the MME 102 according to the address. Besides, a method according to which the IP-SM-GW 104 obtains the message which is before being converting into the short message is not limited. In the above mentioned example, the IP-SM-GW 104 may receive a message as an instant message, a chat session invitation or a chat session teardown request transmitted from an IM capable UE or a converged IP messaging (CPM) capable UE in the wireless communication system 10. In another example, the IP-SM-GW 104 may receive the short message transmitted from a short message service centre (SMS-SC) of the wireless communication system 10.

The UE 100 may be registered in multiple network entities including the IMS domain, the MME 102, etc. In another example, when the short message to be transmitted comes from the SMS-SC and then is forward to the IP-SM-GW 104, the IP-SM-GW 104 may first try to transmit the short message in form of a SIP message to the UE 100 in the IMS domain. If the IP-SM-GW 104 fails to transmit the short message in form of the SIP message in the IMS domain, the IP-SM-GW 104 then tries to transmit the short message to the MME 102 via the interface 108 instead of simply abandoning the transmission of the short message.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method for handling a message transmission. According to the present invention, an IP-SM-GW is able to transmit a short message to a MME via an (newly defined) interface established between the IP-SM-GW and the MME. Thus, a terminating UE registered with the MME can receive the message even if the terminating UE is not reachable due to not being registered in the IMS domain or short of memory capacity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a message service for an Internet Protocol-Short-Message-Gateway (IP-SM-GW) of a wireless communication system, the method comprising:
requesting routing information for a short message to be transmitted to a terminating device from a home subscriber server (HSS)/home location register (HLR)in the wireless communication system, wherein the terminating device is registered with a mobility management entity (MME) of the wireless communication system and the MME supports and performs an SMS in MME feature; and
transmitting the short message to the MME via an interface according to the routing information.

2. The method of claim 1, wherein the short message is being converted from an instant message (IM), a chat session invitation or a chat session teardown request by the IP-SM-GW.

3. The method of claim 1, wherein the routing information comprises an address of the MME.

4. The method of claim 1, further comprising:
receiving a message which is an instant message, a chat session invitation or a chat session teardown request and is transmitted from an IM capable device or a converged IP messaging (CPM) capable device in the wireless communication system; and
converting the received message into the short message.

5. The method of claim 1, further comprising:
receiving the short message transmitted from a short message service centre (SMS-SC) of the wireless communication system.

6. The method of claim 5, wherein the short message is transmitted to the MME via the interface, after the IP-SM-GW fails to transmit the short message in form of a session initiation protocol (SIP) message to the terminating device in an IP multimedia subsystem (IMS) domain.

7. The method of claim 1, wherein the interface is a newly defined interface between the IP-SM-GW and the MME.
